(19) United States
(12) Patent Application Publication
(10) Pub. No.: US 2015/0324057 A1
(43) Pub. Date: Nov. 12, 2015

(54) TOUCH SCREEN ACCESSIBILITY AND FUNCTIONALITY ENHANCEMENT

(71) Applicants: Gholamreza Chaji, Waterloo (CA); Malihe Fakhimi Nassb, Waterloo (CA)

(72) Inventors: Gholamreza Chaji, Waterloo (CA); Malihe Fakhimi Nassb, Waterloo (CA)

(21) Appl. No.: 14/707,115

(22) Filed: May 8, 2015

(30) Foreign Application Priority Data
May 9, 2014 (CA) 2851611

(51) Int. Cl. G06F 3/041

(52) U.S. Cl. CPC G06F 3/0416

(57) ABSTRACT

A display remapping method for improving the device accessibility for touch interaction displays. The method comprises triggering event, remapping function, and termination event. Content of the display is moved to an area with easier accessibility after a trigger event. This provides more ergonomic and ease of use.

### CROSS REFERENCE TO RELATED APPLICATION

This application claims the benefit of Canadian Application No. 2,851,611, filed May 9, 2014, which is hereby incorporated by reference herein in its entirety.

### FIELD OF THE INVENTION

The present disclosure relates to touch screen applications.

### BRIEF SUMMARY

Display remapping, screen, remapping, display content remapping and screen content remapping are used interchangeably herein.

One embodiment is a method of adjusting accessibility of a display by remapping a point of interest in said display content to a more accessible area after a trigger event.

Another embodiment is dynamically remapping the display to move at least one of the points of interest for touch requirements to an easier to access area of the display.

In another embodiment an area in the display is allocated to a virtual window that can hover over the screen and map its contents to the said allocated area.

The remapping of display or virtual window allocation can happen automatically. For example, if the application is required an input from the user which require the use of touch screen, the display content mapping can be adjusted to move the point of interest for touch functionality to the easy to reach area.

In another embodiment the remapping or virtual window allocation is controlled by. Here, the user move the screen mapping around to move the point of interest in the easy to reach area.

In one embodiment, the remapping can be permanent till user changes the mapping again. Whereas in another embodiment, the display mapping can change to its original mapping after some time that can be defined in system setting. In addition, the display mapping can change to its original mapping after the touch functionality is performed. Moreover, the display mapping can also change to its original mapping after user uses a specific gesture. This gesture can be but not limited to slide, push, one or multiple tabs with one or multiple fingers.

In one embodiment, the trigger function can be a specific soft, hard key, a gesture or a combination such functions.

To control the mapping function, in one embodiment, a specific part of the touch screen can be allocated for moving the screen mapping. This part can be part of the active display or outside the active display area.

In another embodiment, a pointer is activated that can access the content in the active area of the display and the main touch screen of the display controls the functionality of the pointer.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 is a demonstration of large screen accessibility for touch screen.

FIG. 2 is an example of sequence for display (content) remapping function for touch functionality.

FIG. 3 is a demonstration of a defining gesture for triggering display remapping.

FIG. 4 is an example of vertical rearrangement (remapping) of display.

FIG. 5 is an example of horizontal rearrangement (remapping) of display.

FIG. 6 is an example for diagonal rearrangement (remapping) of display.

FIG. 7 shows the virtual windows effect on the display.

FIG. 8 shows an example of defining gesture for display remapping.

FIG. 9 shows an example of enabling and disabling a pointer by a defining gesture.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Major issue with touch-screen devices is holding device and using it. These devices consist of a main display having an input screen. In one case, this input device can be a touch screen. Although the document uses touch screen as an example to explain the aspects of the invention, it can be applied to other means of input devices that share the same area as display or map to an area of the display. This is more challenging with larger screen devices. In this case, not only are both hands needed for proper operation of the device but also the screen has hard to reach area for touch functionalities.

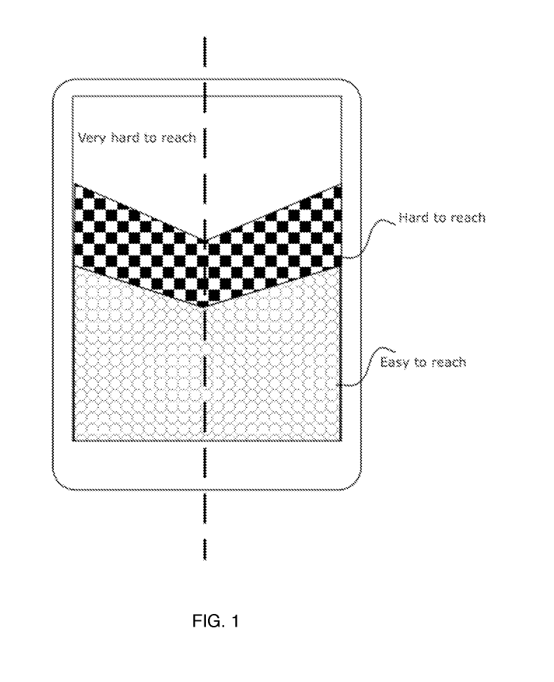

The screen accessibility for touch functionality is demonstrated in FIG. 1. As can be seen, each hand can cover a part of the screen which is easy to reach. The top of the screen is very hard to reach without moving hands. If the devices have a wide display (or the device is used in landscape mode), the middle of the screen maybe hard to reach area as well.

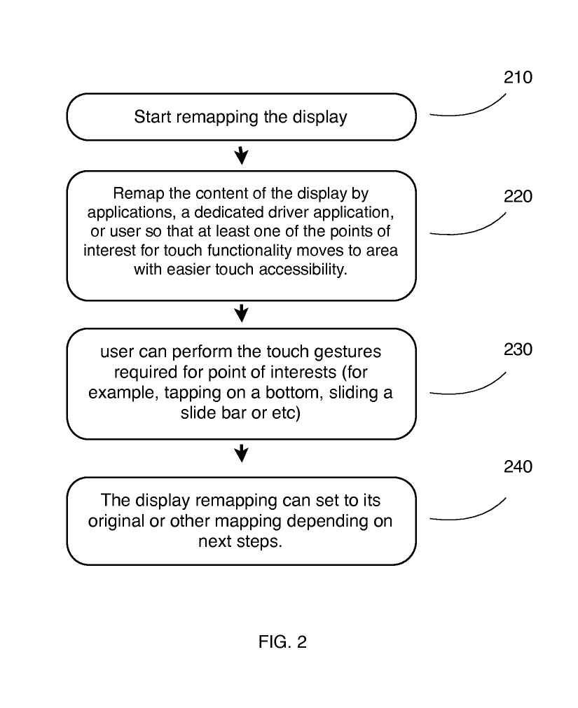

Referring to FIG. 2, the display remapping function can be started with different elements, 210. Here, the display content is remapped so that at least one of the points of interest for touch functionality moves to area with easier touch accessibility 220. The remapping function can be done by application, a driver or the user. In case of application, the mapping can be optimized for each application depending on functionality required for touch point. Also, users can set the remapping adjustment and so optimize the remapping based on their requirements. After remapping, users can perform the required touch gestures for the said point of interests 230. Depending on the next steps after the touch gesture, the display remapping can go to its original, stay in the remapped condition, or move to a different remapping arrangement 240. For example, if touch gesture open a new application that require certain display mapping, the display will be adjusted for that application. In another case, a termination event can end the display remapping. The termination event can be triggered by a specific gesture, a soft key, a hard key, a timer, or an application-controlled event.

A hard key or a soft key can trigger the start of display mapping. Some examples of hard key can be pushing a button or flipping a switch and so on. Examples of soft keys are tapping, moving (or shaking the device), and so on.

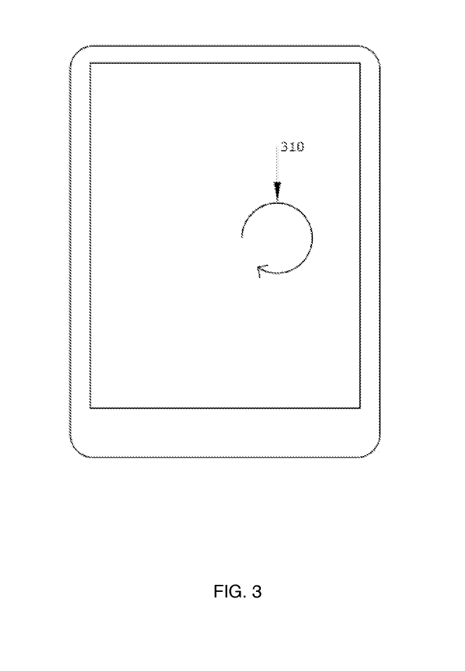

In another case, the remapping can start with a specific gesture or combination of gestures. The gestures should be distinct to avoid confusion between different functions. FIG. 3 shows one possible defining gesture, which is a circular gesture 310. Here, user draws a full or part of a circle 310 on the touch screen.

In another case, the application can trigger the display remapping. In this case, the application moves the access point to area of display with easier accessibility. For example, if there is a button that need to be pushed or a field that need to be field as the next step in the application, the display is remapped automatically to provide easier accessibility for users.

In one aspect of the invention, display remapping consists of but not limited to moving the display content vertically, horizontally, and diagonally or any combination of these movements.

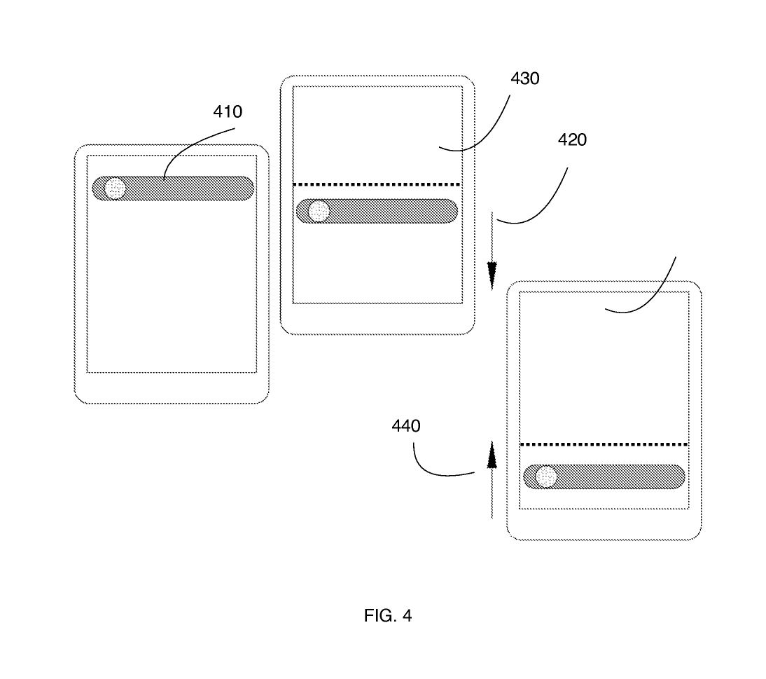

In one example, FIG. 4 highlights a case in which the point of interest 410 for touch functionality is at the top of the display. In this case, the display content can be remapped by moving the contents downward 420 (the contents can wraps around or the top of the display can be filed with a predefined pattern 430). In another case, the content of the display can be remapped by moving the contents upward 440.

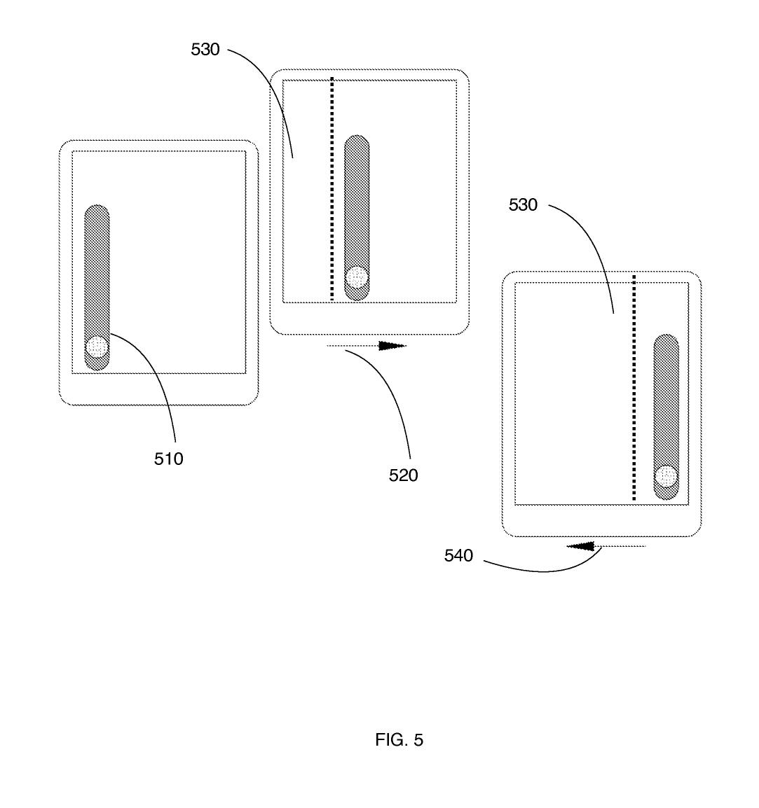

In another example, FIG. 5 highlights a case in which the point of interest 510 for touch functionality is at the left side of the display (assumption is that the user holds the device at the right side. The functionality can be switched if the user hold the device from another side or corner). In this case, the display can be remapped by moving the content to right side 520 (The contents can wrap around or the right side of the display can be filed with a predefined pattern 530). In another case, the display contents can be remapped by moving the contents to the left 540.

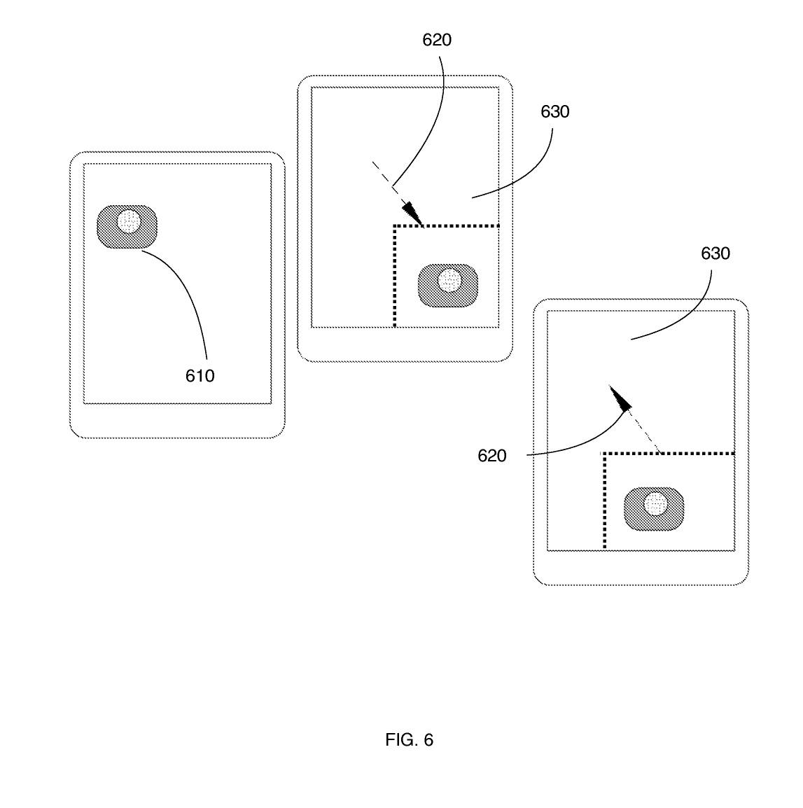

Also, combination of these moves can be used to create complex remapping such as diagonal remapping of the display contents. FIG. 6 shows one example of the complex display remapping. In this case the point of interest 610 for touch functionality is at the corner of the display (it can be at any corner or other positions related to the corner of the display and the movement of remapping can be adjusted based on the position of the point of interest). In this case, the display can be remapped by moving the content by down-right angle 620 (The contents can wrap around or the right side of the display can be filed with a predefined pattern 630). In another case, the display contents can be remapped by moving the contents to the up-left 640. Other complex movement also can be used for display remapping. Here, combination of few gestures can create the complex remapping or a single complex move can create the complex display remapping.

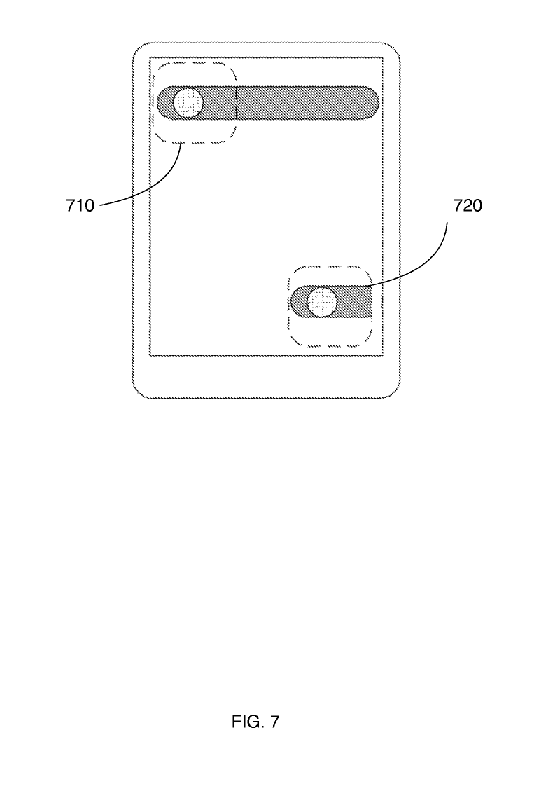

In another example, is a virtual window shown in FIG. 7. In this case, a virtual window 710 (the window can be different shapes such as square, circle, and any other shape) moves across the screen, and the same area covered by such virtual window is remapped to an area of the screen 720 that has easier access for touch screen. This window can be moved around by user, by application or a dedicate application. The window effect can be disabled by a termination event. The said termination event can be activated by user (for example, by touching gesture outside the display, soft key, hard key, or a specific gesture marking end of the window effect), or after specific time that can be set by the user.

In another aspect of this invention, a gesture defines the start point of display remapping followed by other gestures showing the direction, size, and orientation (i.e. defining) of display rearrangement. This is very important for the cases that the touch screen used for display remapping is used for other operations. One example of these cases is the main touch screen sharing some area with the display.

In one example of triggering gesture function, the trigger gesture can be but not limited to a circular move. In this case, the circular move itself could define the size and direction of the movement. For example, the start of the movement can define the start point for display remapping. If the start is at the left (or right) that means the left side will move to right. In another example, the circular gesture can be only the trigger function and the display remapping is controlled by other gestures such as sweeping.

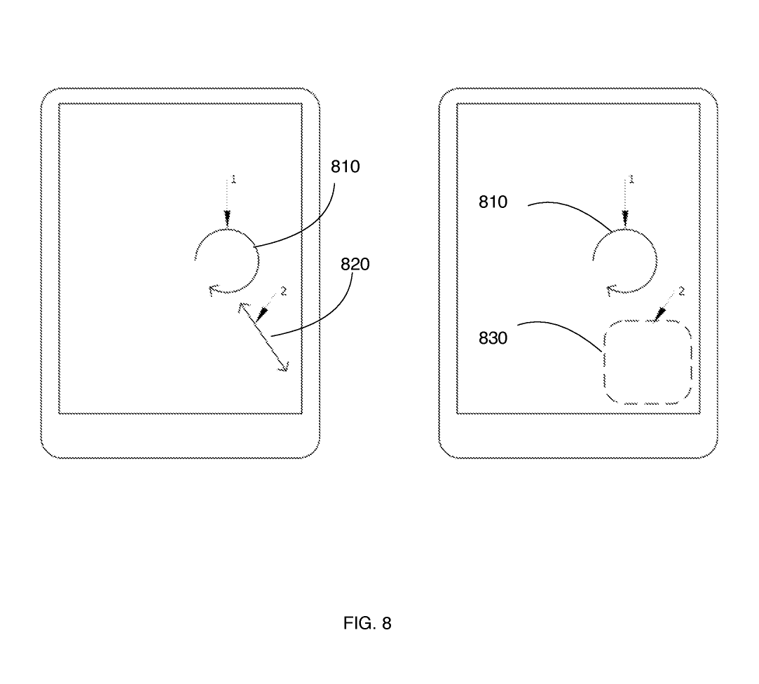

FIG. 8 shows the use of trigger gesture 810 (a circular gesture) to trigger/start the display remapping function. In one example, the display is moved around by other gestures after the trigger gesture (the left diagram) 820. In another example, the defining gesture can enable the window effect (the right diagram) 830.

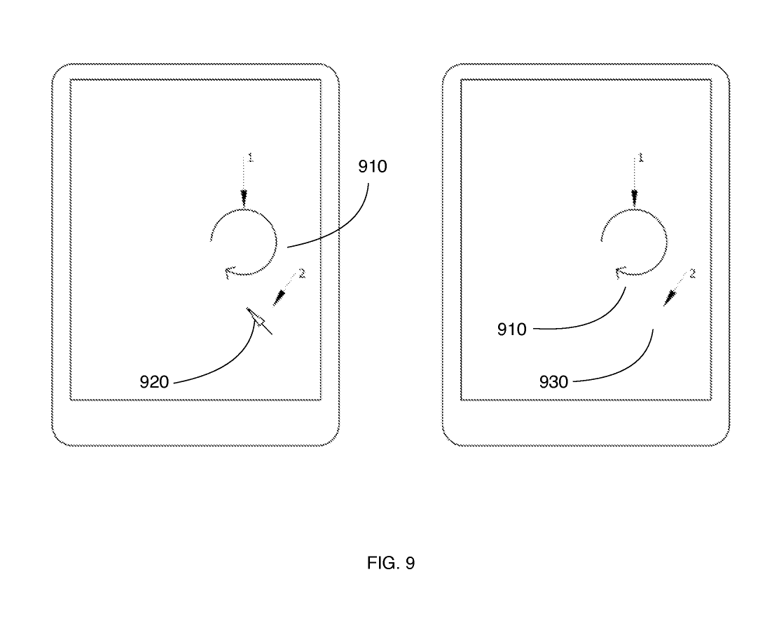

FIG. 9 demonstrate the use of trigger gesture 910 (a circular gesture) to trigger/start the pointer function. After the pointer function 920 or 930 is finished, user can disable the point by a termination gesture (another circular gesture).

In another aspect of the invention, a pointer can be enabled or disabled by a trigger gestures. Here, after enabling the pointer, the display and its associated touch screen support the pointer device.

In another aspect of the invention, the pointer can be enabled or disabled by a soft/hard key. Some examples of hard key can be pushing a button or flipping a switch and so on. Examples of soft keys are tapping, moving (or shaking the device), and so on.

In another aspect of the invention specific area of touch screen can be allocated to the pointer device functionalities. Here, after the pointer is enabled, a specific area of the touch screen can act as the controller for the pointer. This area can be inside or outside the active area.

In another aspect of the invention all of the touch screen supports the pointer functionalities. Here, after the pointer is enabled some gesture of the touch screen are allocated specifically to controlling the pointer functionalities.

In another aspect of the invention, another touch screen at the other side of the device can control the pointer in the active screen after the pointer is enabled. Here, the pointer function can be enabled by default.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

What is claimed is:

1. A method of adjusting accessibility of a display comprising:
receiving a trigger event;
remapping a point of interest in said display to a more accessible area of said display based on said trigger event.

2. The method of claim 1, wherein the said point of interest is moved to an easier accessible area.

3. The method of claim 2, wherein a less accessible area of the display is filled with predefined patterned.

4. The method of claim 2, where a less accessible area of the display is filled with other content remapped with the said trigger.

5. The method of claim 1, wherein the said point of interest is mapped to a window in an easier accessible area of the display.

6. The method of claim 5, wherein a virtual window is mapped to said window and further comprising selecting a content to map to the virtual window.

7. The method of claim 1 wherein said trigger event is generated by a user through one or more of the group comprising a soft key, a hard key and a specific gesture.

8. The method of claim 1 wherein said trigger event is generated automatically by a controller of the display.

9. The method of claim 1 wherein said trigger event is generated automatically by an application using the display.
